(19) United States
(12) Patent Application Publication
(10) Pub. No.: US 2012/0019338 A1
(43) Pub. Date: Jan. 26, 2012

(54) COUPLING STRUCTURES FOR MICROWAVE FILTERS

(76) Inventor: Christine Blair, Queensland (AU)

(21) Appl. No.: 13/063,516

(22) PCT Filed: Sep. 11, 2009
(86) PCT No.: PCT/AU2009/001204

§ 371 Date: Sep. 26, 2011

(30) Foreign Application Priority Data
Sep. 12, 2008 (AU) 2008904762

(51) Int. Cl. H01P 1/20; H01P 11/00; H01P 5/00

(52) U.S. Cl. 333/202; 29/592.1

(57) ABSTRACT

A coupling structure for a microwave filter including at least one coupling rod located adjacent a transformer.

### FIELD OF THE INVENTION

This invention relates to microwave filters, in particular the invention relates to coupling structures used in microwave filters.

### BACKGROUND OF THE INVENTION

Microwave filters are used extensively in radio communications, to ensure that signals from one band of the radio frequency (RF) spectrum do not encroach into another. This is particularly important when used in mobile phone base stations, where interference between bands may mean increased call drop out rates and a reduction in data transmission rates. This is especially the case between the WCDMA and GSM900 bands which are located adjacent each other and often causing substantial interference.

Interference between the WCDMA and GSM900 bands may be reduced by increasing a guard band between the bands. One contributing factor to the size of guard band required is the band edge response of the filter. A sharper transition between the pass band and the reject band means that interference between the two bands is reduced and call quality is improved. A further advantage of sharpening the transition between the pass band and the reject band is that the guard band may be reduced freeing up extra channels for use by customers and creating more revenue for a telecom carrier.

Losses in radio communications systems, such as insertion loss in filters, also contribute to the reduction in call quality. Generally larger amplifiers are used to offset this loss however this is highly undesirable. It is much more preferable to reduce losses in the communication system.

Insertion loss and band edge response may be greatly improved by using ceramic resonators in the filter rather than metallic resonators. Ceramic filters have a higher “Q” and generally have a lower insertion loss and a better band edge response. However this improved performance comes at a cost. Ceramic resonators are approximately 100 times more expensive than metallic resonators.

The cost of a filter may be reduced by replacing some of the ceramic resonators with metallic resonators. As the electric and magnetic fields of metallic and ceramic resonators are orthogonal to each other, it is necessary to mount the metallic resonators at 90 degrees to the ceramic resonators in order that the passage of microwaves through the filter are not impeded. The result is that the tuning screws for the ceramic resonator and the metallic resonator are mounted on different surfaces of the housing. Tuning the filter is therefore more difficult and hence labour costs are higher when producing the filter. Furthermore, manufacture of the filter is more complex.

### OBJECT OF THE INVENTION

It is an object of the invention to overcome or alleviate one or more of the above disadvantages and/or to provide the consumer with a useful or commercial choice.

### SUMMARY OF THE INVENTION

In one form form, although not necessarily the only or broadest form, the invention relates to a coupling structure for a microwave filter including:
at least one coupling rod located adjacent a transformer.

The coupling rod may be a single element adjacent the transformer but is preferably is an open frame element such as a two-pronged fork that straddles the transformer at an angle to the transformer. Alternatively, the coupling rod is a closed frame forming a rectangle. It should be appreciated that the frame may be any suitable shape such as rectangular, square or triangular.

The angle between the transformer and the coupling rod may be between 15 and 85 degrees including 20, 25, 30, 35, 40, 45, 50, 55, 60, 65, 70, 75 and 80 degrees. Preferably the angle is between 40 and 50 degrees. Even more preferably, the angle between the transformer and the coupling rod is 45 degrees.

Suitably the coupling rod and the transformer are made from metal.

Normally the transformer is cylindrical however the transformer may be any other suitable cross sectional shape such as triangular, square or octagonal shape. Ordinarily, the transformer is hollow however the transformer may be solid or partially solid.

Typically, the transformer is secured to a bottom of a housing of the filter and the coupling rod is secured to a top of the housing.

In another form, although not necessarily the only or broadest form, the invention relates to a microwave filter including:
two or more resonators; and
at least one coupling structure positioned between the two or more resonators, the coupling structure including at least one transformer and at least one coupling rod located adjacent to the transformer.

The resonators may be made from a metal or a ceramic material and are substantially hollow however the resonators may also be solid.

In yet another form, although not necessarily the only or broadest form, the invention relates to a method of producing a microwave filter the method including the step of positioning a coupling structure, including a transformer and a coupling rod, between two or more resonators.

In yet another form, although not necessarily the only or broadest form, the invention relates to a coupling structure coupling two resonators in a microwave filter, the coupling structure including:
at least one transformer; and
at least one coupling rod located adjacent to the transformer.

In yet another form, the invention relates to a method of creating a transmission zero at a band edge of a microwave filter response, the method including the step of:
positioning two or more coupling structures, each coupling structure including at least one coupling rod located adjacent a transformer, between three or more resonators.

In the case of coupling between two ceramic resonators and a metallic resonator, the method may include the step of positioning the coupling rods to point substantially in the same direction to create a transmission zero on a low frequency band edge. Alternatively, the method may include the step of positioning the coupling rods to point substantially in opposite directions to create a transmission zero on a high frequency band edge.

In the case of coupling between two metallic resonators and a ceramic resonator, the method may include the step of positioning the coupling rods to point substantially in the same direction to create a transmission zero on a high frequency band edge. Alternatively, the method may include the step of positioning the coupling rods to point substantially opposite directions to create a transmission zero on a low frequency band edge.

### BRIEF DESCRIPTION OF THE DRAWINGS

FIG. 1 shows a plan view of a filter for filtering microwaves.

FIG. 2 is a close-up perspective view of a coupling structure of the filter in FIG. 1;

FIG. 3 is a partial plan view of a filter incorporating the coupling structure of FIG. 2;

FIG. 3a is a graph of the filter response and return loss of a filter incorporating coupling structures arranged in FIG. 3;

FIG. 4 is a partial plan view of a filter incorporating an alternative orientation of the coupling structure of FIG. 2;

FIG. 4a is a graph of the filter response and return loss of a filter incorporating an alternative orientation of the coupling structures of the present invention;

FIG. 5 is a partial plan view of a filter incorporating coupling structures of FIG. 2 between two metallic resonators and a ceramic resonator; and

FIG. 6 is a partial plan view of a filter incorporating coupling structures, using an alternative orientation of the coupling rods, between two metallic resonators and a ceramic resonator.

### DETAILED DESCRIPTION OF THE PREFERRED EMBODIMENT

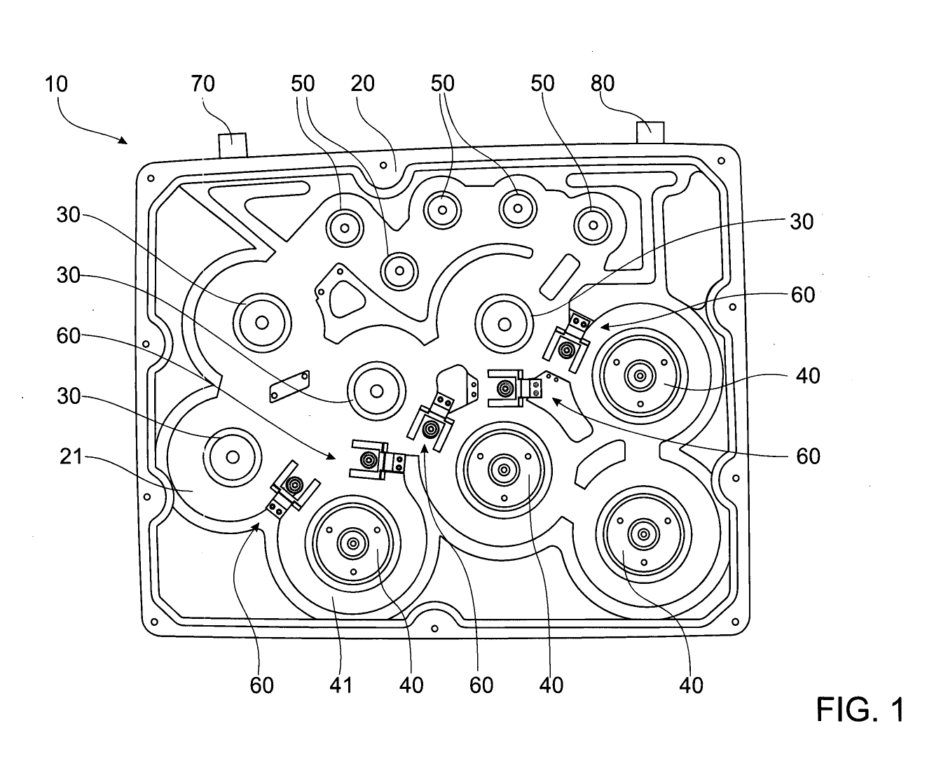

FIG. 1 shows a plan view of a filter 10 for filtering microwaves. The filter 10 includes a housing 20, a series of metallic resonators 30, a series of ceramic resonators 40, a series of receive resonators 50 a series of coupling structures 60 and a lid (not shown).

The housing 20 is made from aluminium or any suitable metal such as steel or metal coated plastic. A cavity 21 is formed in the housing 20 by machining or casting the housing 20. A first port 70 and a second port 80 are connected to the cavity 21.

The metallic resonators 30 and the receive resonators 50 are identical apart from their purpose and are made from aluminium. However any suitable metal such as steel or a metal coated plastic may be used. Resonators 30, 50 may be cast, drawn or machined or integrally moulded into the housing 20. Although the resonators 30, 50 are shown as being hollow it should be appreciated that they may also be solid or partially solid.

The ceramic resonators 40 are made from a ceramic material such as Er45 and positioned inside the cavity 21 on spacers 41 made from plastic or any other insulating material. It should be appreciated that any suitable ceramic material typically from Er20 to Er90 can be used. In addition, the ceramic resonators 40 may have a hole extending through the centre. The Q value of the ceramic resonators 40 is 20,000 at 1 GHz however it should be appreciated that other suitable materials with different Qs may be utilized as would be recognised by a person skilled in the art.

The resonators 30, 40, 50 extend upwardly in the cavity 21 and are secured to the housing 20 by means of screws unless integrally moulded. The shape of the resonators 30, 40, 50 and the spacers 41 is cylindrical however any suitable cross sectional shape such as rectangular, square or triangular may be used.

The lid (not shown) is a flat plate. The lid is made from aluminium however it should be appreciated that the lid may be made from steel or any suitable metal or from a metal coated plastic. The lid has a series of fastening holes to hold the lid to the housing 20. Appropriate fasteners, such as screws, are located through the lid and the housing 20 to hold the lid and the housing 20 together. Tuning screws 90 are located through the lid and coaxially align with the metallic resonators 30, receive resonators 50 and transformers 62.

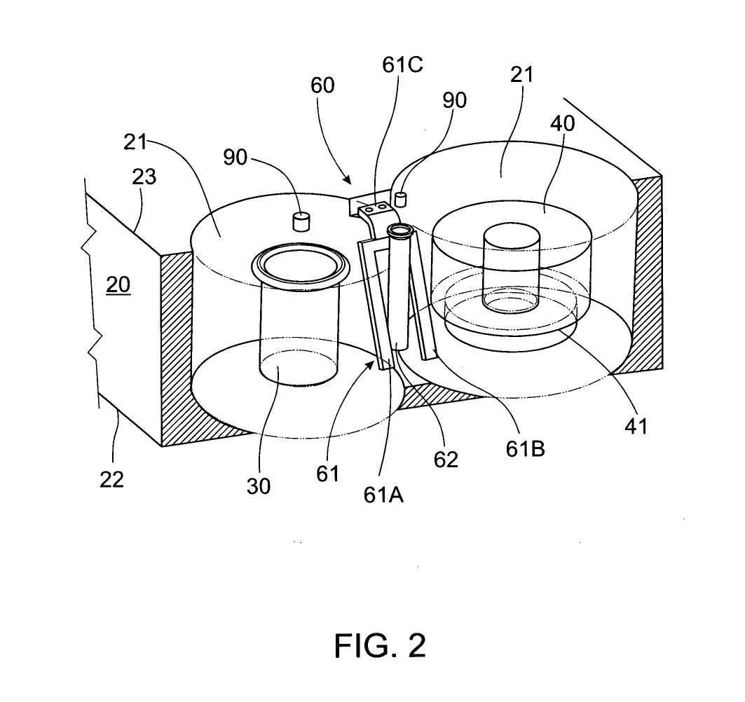

A detailed perspective view of the coupling structure 60 is shown in FIG. 2. In a preferred embodiment the coupling structure 60 includes a coupling rod in the form of a fork 61 and a transformer 62 although the inventors surmise that a single sided element will also be effective albeit to a lesser degree.

The fork 61 is made from aluminium or any other suitable metal such as steel or from a metal coated plastic. The fork 61, has two prongs 61A, 61B connected by a tab 61C, and is bent at a junction between the prongs 61A, 61B and the tab 61C at an angle of between 15 and 85 degrees from a horizontal plane. However the inventors believe that the angle that produces the optimum performance is 45 degrees. It should be noted that the ends of the fork 61 may be joined to form a closed rectangular frame. Alternatively, the shape of the frame may be a triangle, square or any other suitable shape.

The transformer 62 is made of aluminium or any other suitable metal such as steel or from a metal coated plastic. The shape of the transformer 62 is cylindrical however it should be appreciated that the transformer 62 may be a rectangular, square or triangular or any other suitable cross section. Although the transformer 62 is hollow it may equally be solid or partially solid.

The coupling structure 60 is positioned between the metallic resonator 30 and the ceramic resonator 40. Firstly, the transformer is attached to a bottom 22 of the housing. Then the fork is secured to a top 23 of the housing 20 around the transformer 62 such that the prongs 61A, 61B of the fork 61 are orthogonal to the axis formed between the centre of the ceramic resonator 40 and the centre of the metallic resonator 30. It should be noted that an area of the housing 20 where the tab 61C of the fork 61 is attached should be flat, so that the fork 61 makes sufficient contact with the housing 20, to achieve good Product of Intermodulation (PIM) results.

In use, the filter 10 is placed in a system where transmit microwaves are fed into the first port 70 and receive microwaves are fed into the second port 80. The transmit microwaves propagate through the cavity 21 between metallic resonators 30 and ceramic resonators 40 via coupling structures 60 and exit the housing 20 via the second port 80. Similarly, the receive microwaves propagate through the cavity 21 between receive resonators 50 and exit the cavity 21 out of the first port 70.

An advantage of the filter 10 is that the microwaves can couple between a metallic resonator 30 and a ceramic resonator 40. Fields generated by metallic resonators 30 and ceramic resonators 40 are orthogonal to each other and do not easily couple. However the coupling structure 60 placed between the metallic resonator 30 and the ceramic resonator 40 allow the fields to couple effectively. Furthermore, this allows the tuning screws 90 to be mounted on the same face of the filter 10.

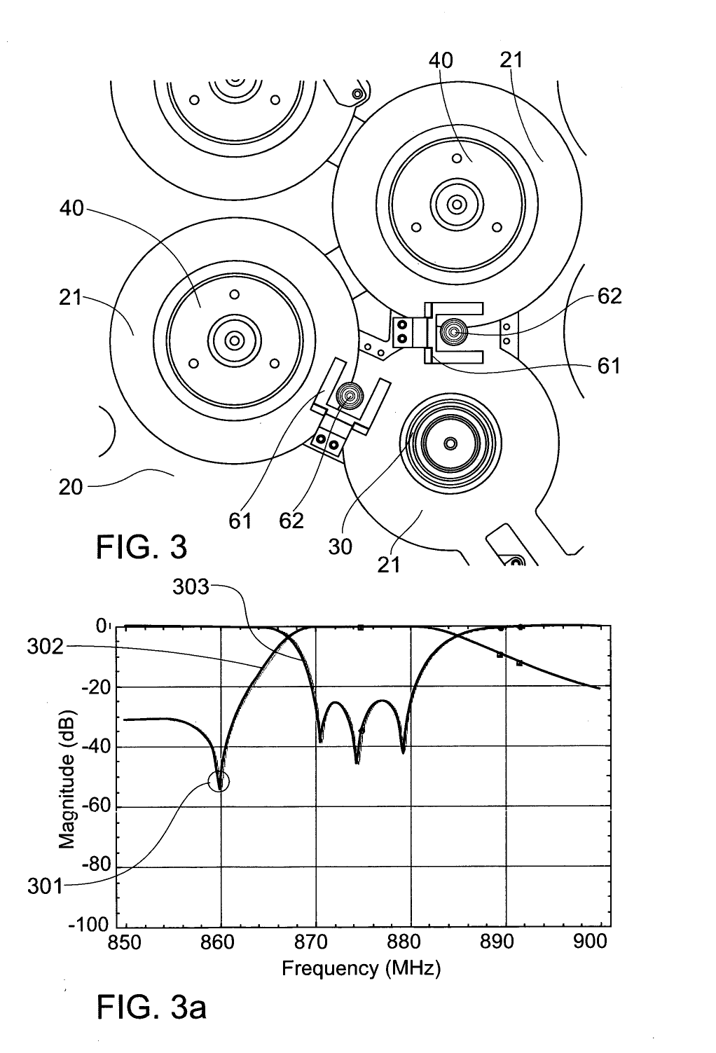

The inventors have found that coupling structures 60 placed between metallic resonators 30 and ceramic resonators 40 also create transmission zeros at the band edges and hence produce sharper band edges. FIG. 3 shows a plan view of the filter 10 of FIG. 1 where a metallic resonator 30 is coupled to two ceramic resonators 40 configured in a “triplet” arrangement. In this case the prongs of the forks 61 point substantially in the same direction. The filter response of this configuration is shown by curve 302 and the return loss is shown by curve 303 in FIG. 3a. Here a transmission zero 301 is created on the low frequency band edge creating a sharper low frequency band edge.

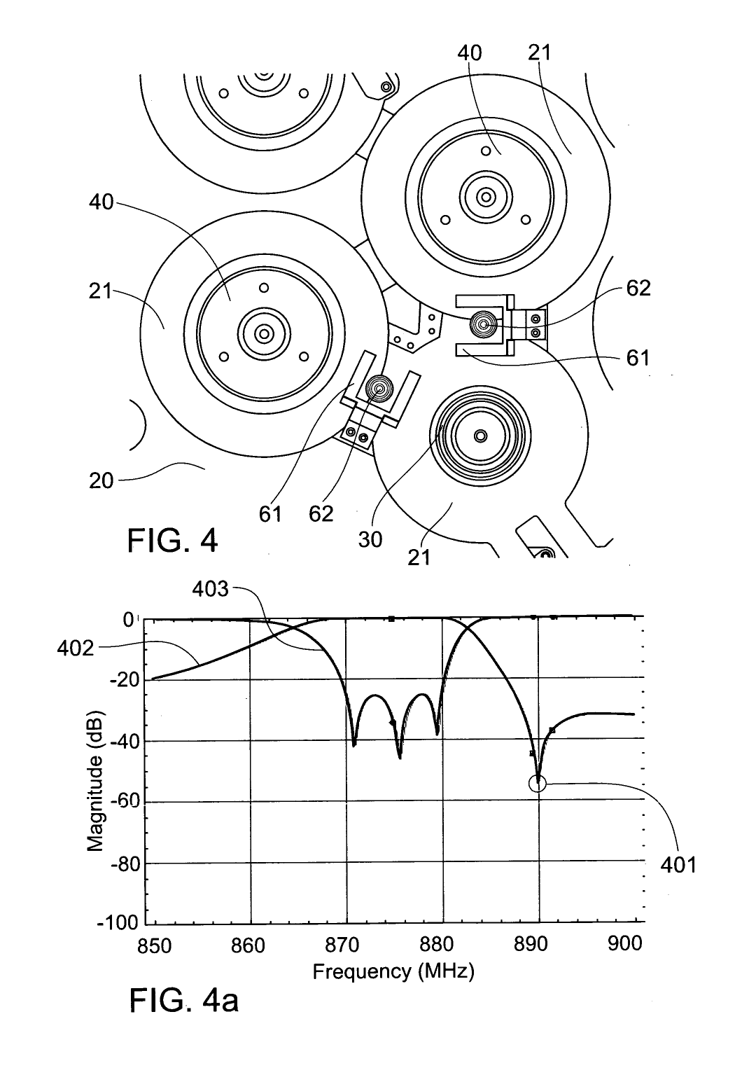

Similarly, FIG. 4 shows a plan view of the filter 10 of FIG. 1 where the prongs of the forks 61 point in substantially opposite directions. The filter response of this configuration is shown by curve 402 and the return loss is shown by curve 403 of FIG. 4a. Here a transmission zero 401 is created on the high frequency band edge creating a sharper high frequency band edge. Simply by changing the orientation of one fork 61 has the effect of moving the transmission zero 301, 401 between the band edges meaning that filter configurations can be changed more quickly.

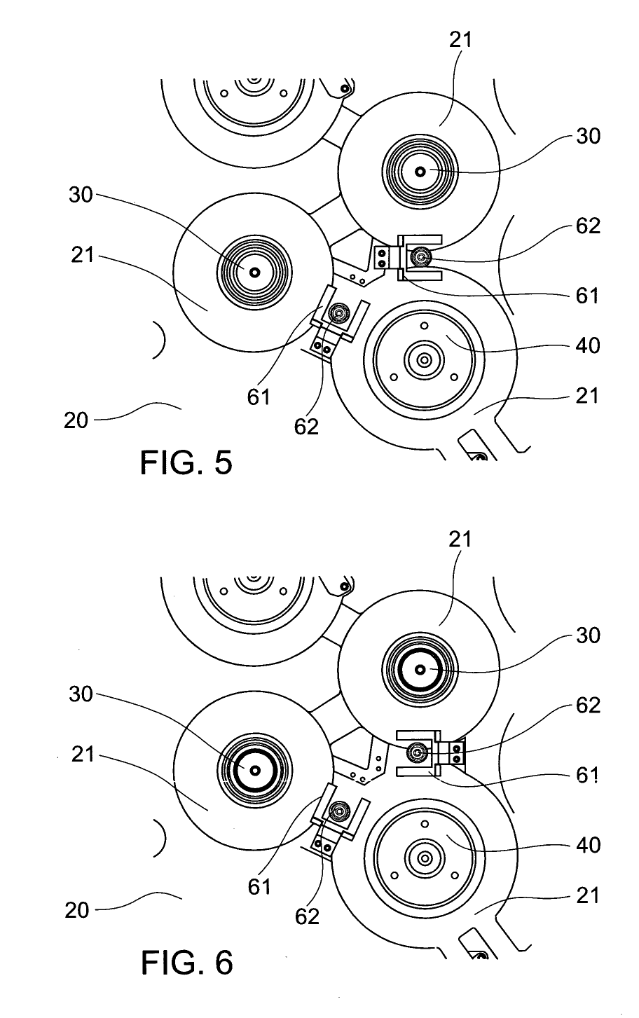

Transmission zeros are also created when a ceramic resonator 40 is coupled to two metallic resonators 30 using the coupling structures 60 of the present invention. FIG. 5 shows a plan view of a filter 10, including a ceramic resonator 40 coupled to two metallic resonators 30, where the prongs of the forks 61 in substantially the same direction. In this case a transmission zero 401 is created on the high frequency band edge as shown in FIG. 4a.

FIG. 6 shows a plan view of a filter 10, including two metallic resonators 30 and a ceramic resonator, where the prongs of the forks 61 point in substantially opposite directions. In this case a transmission zero 301 is created on the low frequency band edge as shown in FIG. 3a.

The inventors believe that transmission zeros may be created when the coupling structure 60 is used to couple resonators made from the same material.

The coupling structure 60 of the present invention produces many benefits. To summarise, the advantages are:
Ceramic resonators, metallic resonators and transformers may be mounted in the same axis in a filter so that the all tuning screws can be mounted on the same face of the filter.
Mounting all tuning screws in the same face allows the filter to be more easily tuned reducing labour costs.
Replacing some ceramic resonators with metallic resonators significantly reduces the cost of the filter.
The filter incorporating the coupling structure may be configured to produce a sharper response at the band edges.
The coupling structure does not reduce the unloaded “Q” of the metallic resonator or the ceramic resonator.
A large tuning range is possible so mechanical tolerances are not critical, further reducing tooling costs.

1. A coupling structure for a microwave filter including:
at least one coupling rod located adjacent a transformer.

2. The coupling structure of claim 1 wherein the coupling rod is a single element adjacent the transformer.

3. The coupling structure of claim 1 wherein the coupling rod is an open frame element.

4. The coupling structure of claim 1 wherein the coupling rod is a two-pronged fork that straddles the transformer at an angle to the transformer.

5. The coupling structure of claim 1 wherein the coupling rod is a closed frame forming a rectangle.

6. The coupling structure of claim 1 wherein the coupling rod a closed frame forming a square.

7. The coupling structure of claim 1 wherein the coupling rod a closed frame forming a triangle.

8. The coupling structure of claim 1 wherein an angle between the transformer and the coupling rod is between 15 and 85 degrees.

9. The coupling structure of claim 1 wherein an angle between the coupling rod and the transformer is between 40 and 50 degrees.

10. The coupling structure of claim 1 wherein an angle between the coupling rod and the transformer is 45 degrees.

11. The coupling structure of claim 1 wherein the transformer is secured to a bottom of a housing of the filter and the coupling rod is secured to a top of the housing.

12. A microwave filter including:
two or more resonators; and
at least one coupling structure positioned between the two or more resonators, the coupling structure including at least one transformer and at least one coupling rod located adjacent to the transformer.

13. The microwave filter of claim 12 wherein the resonators are made from a metal or a ceramic material.

14. The microwave filter of claim 12 wherein the coupling rod is a two-pronged fork that straddles the transformer at an angle to the transformer.

15. A method of producing a microwave filter the method including the step of positioning a coupling structure, including a transformer and a coupling rod, between two or more resonators.

16. A coupling structure coupling two resonators in a microwave filter, the coupling structure including:
at least one transformer; and
at least one coupling rod located adjacent to the transformer.

17. The coupling structure of claim 16 wherein the coupling rod is a two-pronged fork that straddles the transformer at an angle to the transformer.

18. A method of creating a transmission zero at a band edge of a microwave filter response, the method including the step of:
positioning two or more coupling structures, each coupling structure including at least one coupling rod located adjacent a transformer, between three or more resonators.

19. The method of claim 18 wherein the resonators include a metallic resonator and two ceramic resonators.

20. The method of claim 18 wherein the resonators include two metallic resonators and a ceramic resonator.
